(19) United States
(12) Patent Application Publication
(10) Pub. No.: US 2011/0074972 A1
(43) Pub. Date: Mar. 31, 2011

(54) IMAGE PROCESSING APPARATUS

(75) Inventor: Hideto Fujita, Osaka (JP)

(73) Assignee: SANYO ELECTRIC CO., LTD., Osaka (JP)

(21) Appl. No.: 12/893,739

(22) Filed: Sep. 29, 2010

(30) Foreign Application Priority Data
Sep. 30, 2009 (JP) 2009-226082

(51) Int. Cl. H04N 5/228

(52) U.S. Cl. 348/222.1; 348/E05.031

(57) ABSTRACT

An image processing apparatus includes a fetcher. A fetcher fetches an original image. A first converter converts the original image fetched by the fetcher into a first recording image. A second converter converts the original image fetched by the fetcher into a second recording image, in association with the converting process of the first converter. A first editor edits one of the first recording image converted by the first converter and the second recording image converted by the second converter, in response to an editing instruction. A second editor edits the other of the first recording image converted by the first converter and the second recording image converted by the second converter, corresponding to the editing process of the first editor.

### CROSS REFERENCE OF RELATED APPLICATION

The disclosure of Japanese Patent Application No. 2009-226082, which was filed on Sep. 30, 2009, is incorporated herein by reference.

### BACKGROUND OF THE INVENTION

1. Field of the Invention

The present invention relates to an image processing apparatus. More particularly, the present invention relates to an image processing apparatus which is applied to a digital video camera and which creates a plurality of recording images representing a common scene.

2. Description of the Related Art

According to one example of this type of apparatus, a video signal outputted from a camera section is recorded as a moving image on a tape cassette, and at the same time, the video signal is recorded as a moving-image file on a memory card. When a delete button is manipulated, the corresponding moving-image file is deleted from the memory card. It is noted that the video signal recorded on the tape cassette remains on the tape cassette irrespective of the manipulation of the delete button.

In the above-described apparatus, however, when the delete button is manipulated, consistency between the video recorded on the tape cassette and that recorded on the memory card collapses. Thus, in the above-described apparatus, it is probable that management of the recorded video becomes complicated.

### SUMMARY OF THE INVENTION

An image processing apparatus according to the present invention comprises: a fetcher which fetches an original image; a first converter which converts the original image fetched by the fetcher into a first recording image; a second converter which converts the original image fetched by the fetcher into a second recording image, in association with the converting process of the first converter; a first editor which edits one of the first recording image converted by the first converter and the second recording image converted by the second converter, in response to an editing instruction; and a second editor which edits the other of the first recording image converted by the first converter and the second recording image converted by the second converter, corresponding to an editing process of the first editor.

An image-process program product executed by a processor of an image processing apparatus, comprises: a fetching step of fetching an original image; a first converting step of converting the original image fetched by the fetching step into a first recording image; a second converting step of converting the original image fetched by the fetching step into a second recording image, in association with the converting process of the first converting step; a first editing step of editing one of the first recording image converted by the first converting step and the second recording image converted by the second converting step, in response to an editing instruction; and a second editing step of editing the other of the first recording image converted by the first converting step and the second recording image converted by the second converting step, corresponding to an editing process of the first editing step.

An image processing method executed by an image processing apparatus, comprises: a fetching step of fetching an original image; a first converting step of converting the original image fetched by the fetching step into a first recording image; a second converting step of converting the original image fetched by the fetching step into a second recording image, in association with the converting process of the first converting step; a first editing step of editing one of the first recording image converted by the first converting step and the second recording image converted by the second converting step, in response to an editing instruction; and a second editing step of editing the other of the first recording image converted by the first converting step and the second recording image converted by the second converting step, corresponding to an editing process of the first editing step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an allocation state of two cut-out areas in a raw image area of the SDRAM;

FIG. 5(A) is an illustrative view showing one example of a setting menu;

FIG. 5(B) is an illustrative view showing another example of the setting menu;

FIG. 5(C) is an illustrative view showing still another example of the setting menu;

FIG. 6 is an illustrative view showing one example of a directory structure formed on a recording medium;

FIG. 7 is an illustrative view showing one example of a file management table referred to by the embodiment in FIG. 2;

FIG. 8 is an illustrative view showing one portion of reproducing behavior executed by the embodiment in FIG. 2;

FIG. 9 is a flowchart showing one portion of behavior of a CPU applied to the embodiment in FIG. 2;

FIG. 10 is a flowchart showing another portion of the behavior of the CPU applied to the embodiment in FIG. 2;

FIG. 11 is a flowchart showing still another portion of the behavior of the CPU applied to the embodiment in FIG. 2;

FIG. 12 is a flowchart showing yet another portion of the behavior of the CPU applied to the embodiment in FIG. 2;

FIG. 13 is a flowchart showing another portion of the behavior of the CPU applied to the embodiment in FIG. 2;

FIG. 14 is a flowchart showing still another portion of the behavior of the CPU applied to the embodiment in FIG. 2;

FIG. 15 is a flowchart showing yet another portion of the behavior of the CPU applied to the embodiment in FIG. 2;

FIG. 16 is a flowchart showing another portion of the behavior of the CPU applied to the embodiment in FIG. 2; and

FIG. 17 is a flowchart showing still another portion of the behavior of the CPU applied to the embodiment in FIG. 2.

### DETAILED DESCRIPTION OF THE PREFERRED EMBODIMENTS

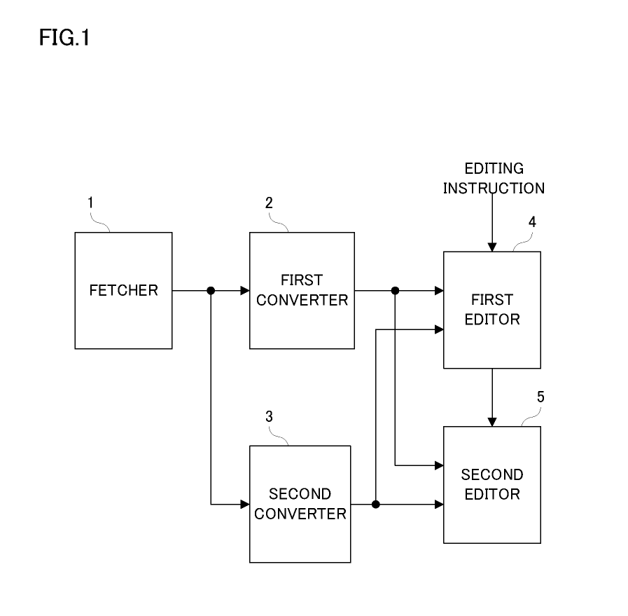

With reference to FIG. 1, an image processing apparatus of one embodiment of the present invention is basically configured as follows: A fetcher 1 fetches an original image. A first converter 2 converts the original image fetched by the fetcher 1 into a first recording image. A second converter 3 converts the original image fetched by the fetcher 1 into a second recording image, in association with the converting process of the first converter 2. A first editor 4 edits one of the first recording image converted by the first converter 2 and the second recording image converted by the second converter 3, in response to an editing instruction. A second editor 5 edits the other of the first recording image converted by the first converter 2 and the second recording image converted by the second converter 3, corresponding to the editing process of the first editor 4.

Because the first converter 2 and the second converter 3 perform the converting process on the common original image, a common scene appears in the first recording image and the second recording image. When one of the first recording image and the second recording image is edited by the first editor 4, the other of the first recording image and the second recording image is edited by the second editor 5 in a corresponding manner. Thereby, it becomes possible to reduce complications caused at the time of managing or editing a plurality of recording images representing the common scene.

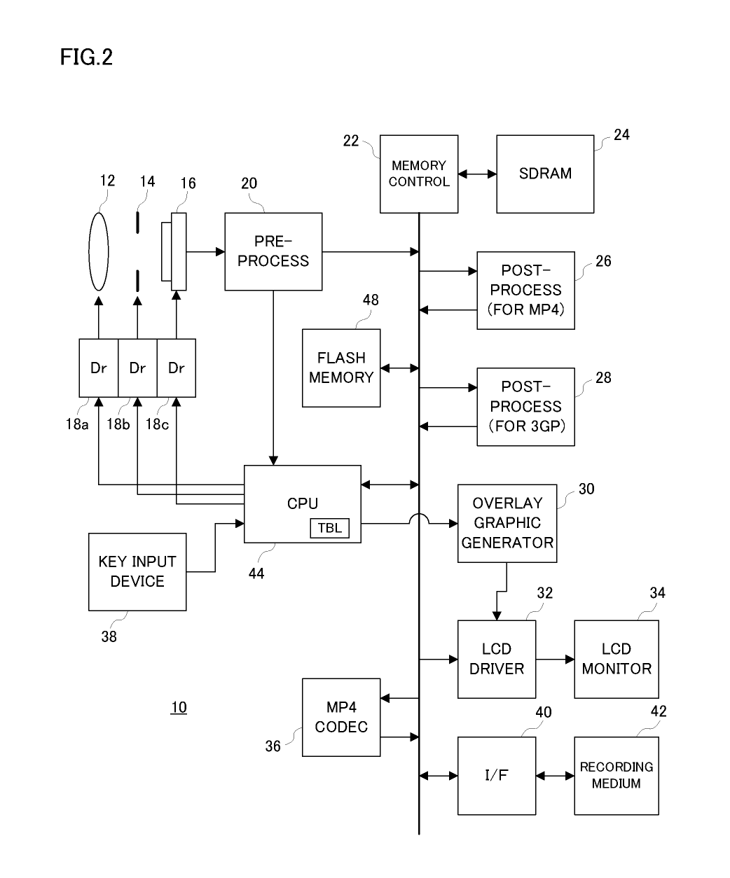

With reference to FIG. 2, a digital video camera 10 according to this embodiment includes a focus lens 12 and an aperture unit 14 respectively driven by drivers 18a and 18b. An optical image representing a scene enters, with irradiation, an imaging surface of an image sensor 16 through these members. It is noted that an effective image area on the imaging surface has a resolution of horizontal 2560 pixels×vertical 1600 pixels.

When a camera mode is selected by a key input device 38, a CPU 44 starts up a driver 18c in order to execute a moving-image fetching process under an imaging task. In response to a vertical synchronization signal Vsync generated at every 1/60th of a second, the driver 18c exposes the imaging surface and reads out electric charges produced on the imaging surface in a non-interlaced scanning manner. From the image sensor 16, raw image data representing the scene is outputted at a frame rate of 60 fps.

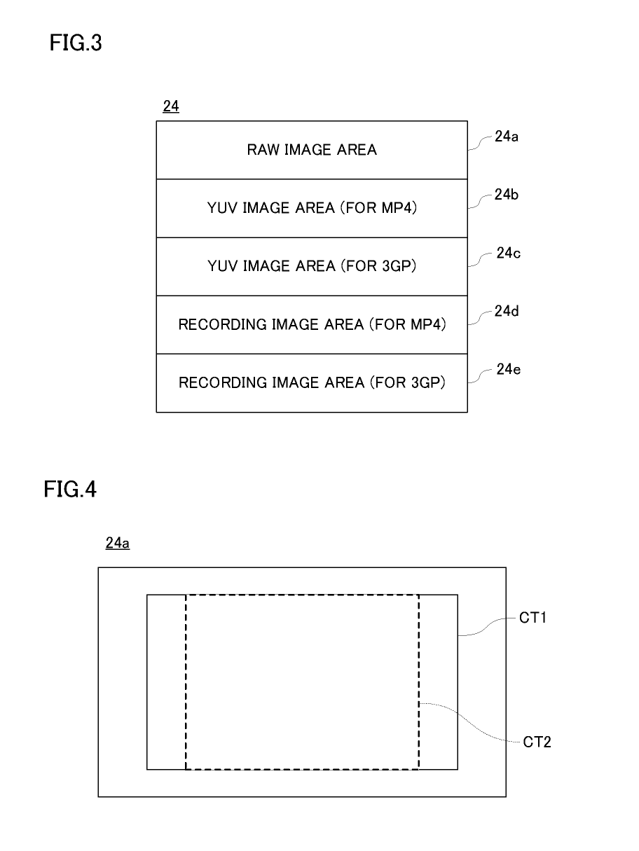

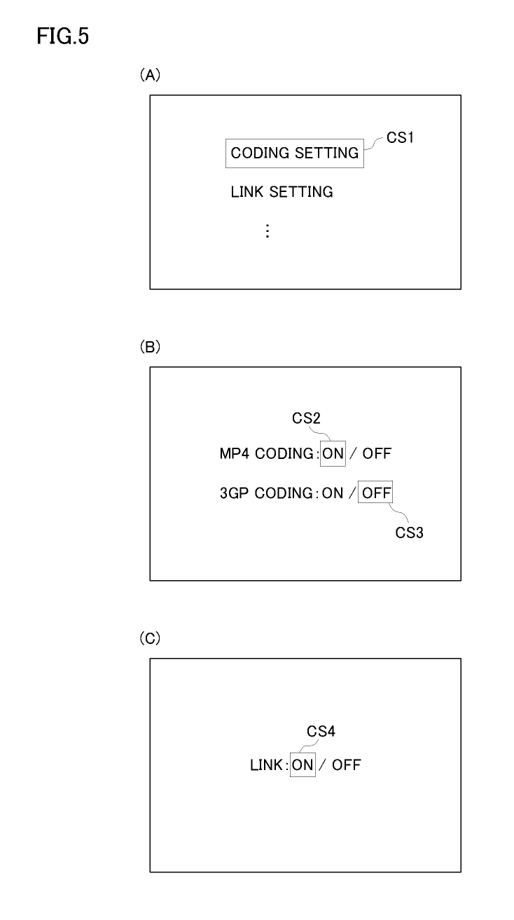

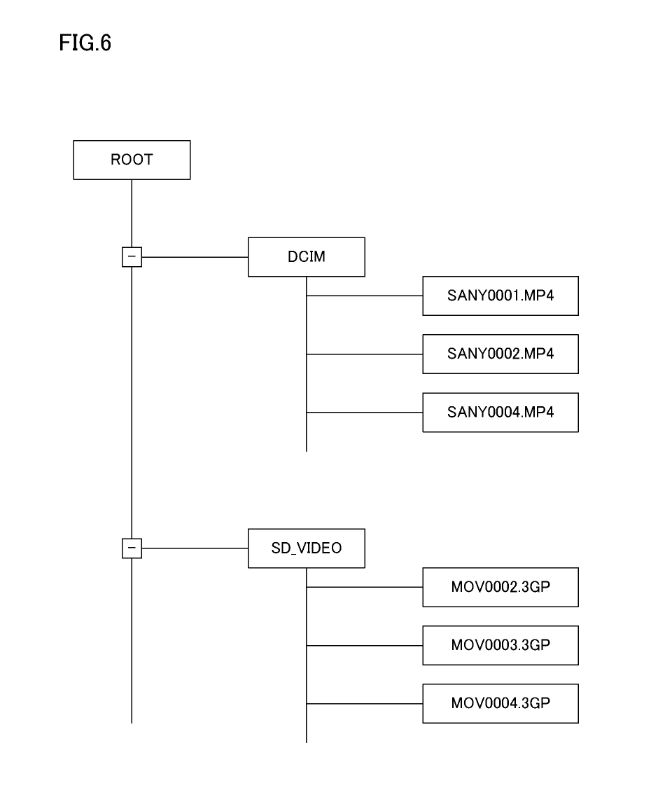

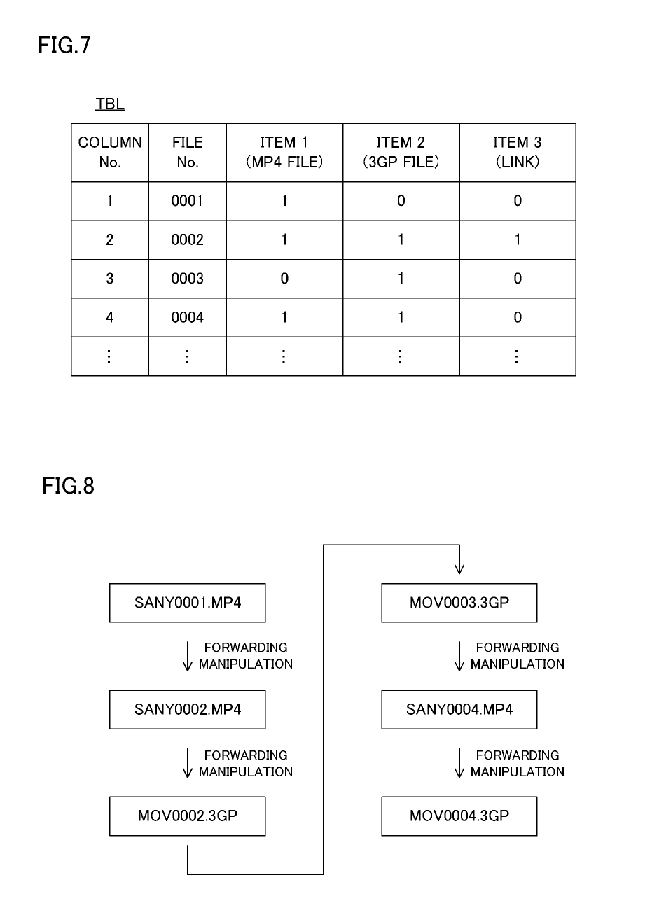

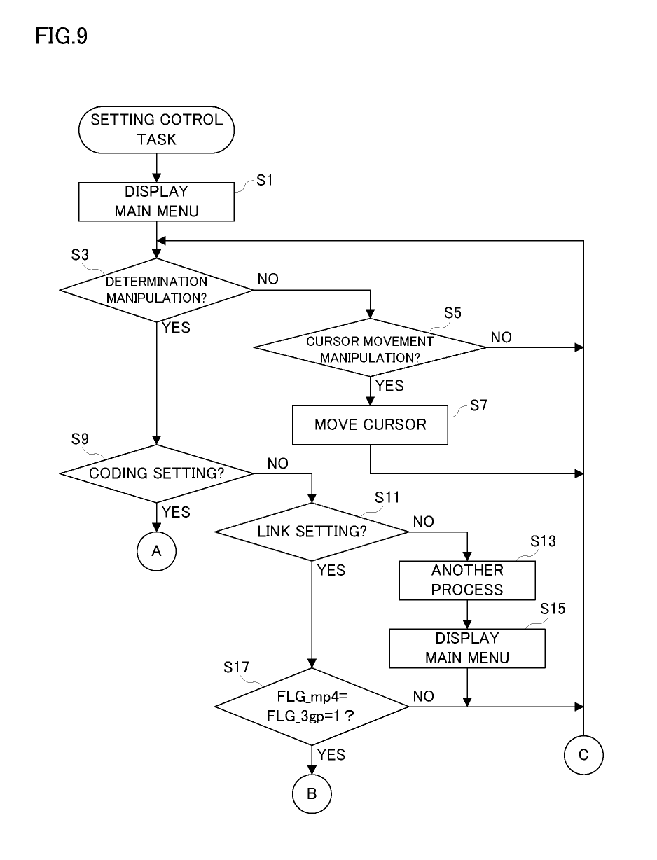

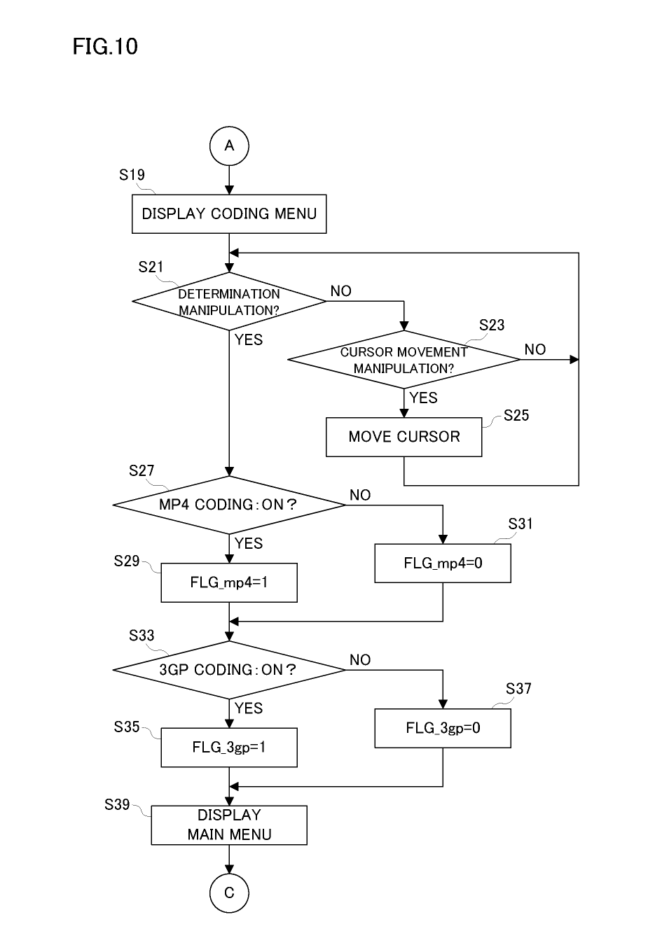

A pre-processing circuit 20 performs processes, such as digital clamp, pixel defect correction, and gain control, on the raw image data from the image sensor 16. The raw image data on which such pre-processes are performed is written into a raw image area 24a (see FIG. 3) of an SDRAM 24 through a memory control circuit 22.

With reference to FIG. 4, cut-out areas CT1 and CT2 are allocated to the raw image area 24a. The cut-out area CT1 has a resolution equivalent to horizontal 1920 pixels×vertical 1080 pixels (its aspect ratio is 16:9). On the other hand, the cut-out area CT2 has a resolution equivalent to horizontal 640 pixels×vertical 480 pixels (its aspect ratio is 4:3).

A post-processing circuit 26 accesses the raw image area 24a through the memory control circuit 22 so as to read out the raw image data corresponding to the cut-out area CT1 at every 1/60th of a second in an interlaced scanning manner. The read-out raw image data is subjected to processes such as color separation, white balance adjustment, YUV conversion, edge emphasis, and zoom operation. As a result, image data corresponding to a 1080/60i system is created. The created image data is written into a YUV image area 24b (see FIG. 3) of the SDRAM 24 through the memory control circuit 22.

An LCD driver 32 repeatedly reads out the image data accommodated in the YUV image area 24b, reduces the read-out image data so as to be adapted to the resolution of an LCD monitor 34, and drives the LCD monitor 34 based on the reduced image data. As a result, a real-time moving image (through image) representing the scene is displayed on a monitor screen.

Moreover, the pre-processing circuit 20 simply converts the raw image data into Y data, and applies the converted Y data to the CPU 44. The CPU 44 performs an AE process on the Y data under an imaging-condition adjusting task so as to calculate an appropriate EV value. An aperture amount and an exposure time period defining the calculated appropriate EV value are set to the drivers 18b and 18c, respectively, and as a result, the brightness of the through image is moderately adjusted. Furthermore, the CPU 44 performs an AF process on a high-frequency component of the Y data when an AF start-up condition is satisfied. The focus lens 12 is placed at a focal point by the driver 18a, and as a result, the sharpness of the through image is continuously improved.

Moreover, in order to detect a motion of the imaging surface in a direction orthogonal to an optical axis, the CPU 44 executes a motion-detection process in which the Y data is referred to. The CPU 44 moves the cut-out areas CT1 and CT2 so that a camera shake is compensated when the detected motion is equivalent to the camera shake of the imaging surface. This inhibits a through-image vibration resulting from the camera shake.

When a setting adjusting mode is selected by the key input device 38, the CPU 44 issues a main-menu display command toward an overlay graphic generator 30. As a result, a main menu shown in FIG. 5(A) is displayed on the LCD monitor 34. According to FIG. 5(A), the main menu has a plurality of items such as “coding setting” and “link setting”, and any one of the items is pointed at by a cursor CS1.

The cursor CS1 moves to a desired location in response to a cursor movement manipulation toward the key input device 38. When a determination manipulation is performed on the key input device 38, a process different depending on each pointing destination of the cursor CS1 is executed as follows:

When the pointing destination of the cursor CS1 is “coding setting”, a coding-menu display command is issued toward the overlay graphic generator 30. A display of the LCD monitor 34 is updated from the main menu shown in FIG. 5(A) to a coding menu shown in FIG. 5(B). According to FIG. 5(B), the coding menu has two items, i.e., “MP4 coding” and “3GP coding”.

A cursor CS2 points at one of two items, i.e., “ON” and “OFF” allocated to the “MP4 coding”, and a cursor CS3 points at one of two items, i.e., “ON” and “OFF” allocated to the “3GP coding”. The cursor CS2 and/or CS3 moves to a desired location in response to the cursor movement manipulation.

When the determination manipulation is performed, a value of a flag FLG_mp4 is adjusted so as to be adapted to the pointing destination of the cursor CS2, and a value of a flag FLG_{—}3gp is adjusted so as to be adapted to the pointing destination of the cursor CS3.

The flag FLG_mp4 is set to “1” when the cursor CS2 points at “ON”, and set to “0” when the cursor CS2 points at “OFF”. Similarly, the flag FLG_{—}3gp is set to “1” when the cursor CS3 points at “ON”, and set to “0” when the cursor CS3 points at “OFF”.

The display of the LCD monitor 34 is returned to the main menu shown in FIG. 5(A) after setting of the flags FLG_mp4 and FLG_{—}3gp is completed.

If the determination manipulation is performed in a state where the cursor CS1 points at the “link setting” on the main menu, then a link-menu display command is issued toward the overlay graphic generator 30 as long as both the flags FLG_mp4 and FLG_{—}3gp indicate “1”. That is, in a case where at least one of the flags FLG_mp4 and FLG_{—}3gp indicates “0”, selection of the item of “link setting” is prohibited.

When the link-menu display command is issued, the display of the LCD monitor 34 is transitioned from the main menu shown in FIG. 5(A) to a link menu shown in FIG. 5(C). According to FIG. 5(C), the link menu has an item of “link”, and a cursor CS4 points at one of two items, i.e., “ON” and “OFF”. The cursor CS4 is transitioned between “ON” and “OFF” in response to the cursor movement manipulation.

When the determination manipulation is performed in a state where the cursor CS4 points at “ON”, a flag FLG_Link is set to “1”. On the other hand, when the determination manipulation is performed in a state where the cursor CS4 points at “OFF”, the flag FLG_Link is set to “0”. The display of the LCD monitor 34 is returned from the link menu to the main menu after the setting process of the flag FLG_Link is completed.

It is noted that the flags FLG_mp4, FLG_{—}3gp, and FLG_Link are managed in a non-volatile state, and all indicate “1” in a default state. The above-described setting process is equivalent to a process for updating values of the flags FLG_mp4, FLG_{—}3gp, and FLG_Link.

When the operation mode is returned to the camera mode, the above-described moving-image fetching process is resumed. If a recording start manipulation is performed on the key input device 38 in this state, then the CPU 44 executes a process different depending on the state of the flags FLG_mp4 and FLG_{—}3gp under the imaging task.

When the value of the flag FLG_mp4 indicates “1”, the CPU 44 creates an MP4 file on a recording medium 42 through an PF 40 (the created MP4 file is opened), and corresponding to the MP4 file, the CPU 44 starts up an MP4 codec 36. The MP4 codec 36 reads out the image data accommodated in the YUV image area 24b through the memory control circuit 22, compresses the read-out image data according to an MPEG4 system, and writes the compressed image data into a recording image area 24d (see FIG. 3) through the memory control circuit 22.

Furthermore, when the value of the flag FLG_{—}3gp indicates “1”, the CPU 44 creates a 3GP file on the recording medium 42 through the PF 40 (the created 3GP file is opened), and corresponding to the 3GP file, the CPU 44 starts up a post-processing circuit 28 and the MP4 codec 36.

The post-processing circuit 28 accesses the raw image area 24a through the memory control circuit 22 so as to read out the raw image data belonging to the cut-out area CT2 at every 1/30th of a second in an interlaced scanning manner. The read-out raw image data is subjected to processes such as color separation, white balance adjustment, YUV conversion, edge emphasis, and zoom operation. As a result, the image data corresponding to a 480/30i system is outputted from the post-processing circuit 28. The outputted image data is written into a YUV image area 24c (see FIG. 3) of the SDRAM 24 through the memory control circuit 22.

The MP4 codec 36 reads out the image data accommodated in the YUV image area 24c through the memory control circuit 22, compresses the read-out image data according to the MPEG4 system, and writes the compressed image data into a recording image area 24e (see FIG. 3) through the memory control circuit 22.

Moreover, the CPU 44 commands the I/F 40 to perform a recording process under a recording control task, in association with the start up of the MP4 codec 36. When the value of the flag FLG_mp4 indicates “1”, the I/F 40 reads out the compressed image data accommodated in the recording image area 24d through the memory control circuit 22, and writes the read-out compressed image data into the MP4 file in the opened state. Furthermore, when the value of the flag FLG_{—}3gp indicates “1”, the I/F 40 reads out the compressed image data accommodated in the recording image area 24e through the memory control circuit 22, and writes the read-out compressed image data into the 3GP file in the opened state.

A file name of SANY****.MP4 (**** is an identification number. The same applies hereinafter) is allocated to the MP4 file, and a file name of MOV****.3GP is allocated to the 3GP file. Moreover, a common identification number is allocated to the simultaneously created MP4 file and 3GP file. The recording medium 42 has a directory structure shown in FIG. 6, and the MP4 file is created at a lower hierarchy of a directory DCIM while the 3GP file is created at a lower hierarchy of a directory SD_VIDEO.

When a recording end manipulation is performed on the key input device 38, the CPU 44 stops the MP4 codec 36 under the imaging task. When the flag FLG_mp4 indicates “1”, the CPU 44 closes the MP4 file of a writing destination through the I/F 40. Furthermore, when the flag FLG_{—}3gp indicates “1”, the CPU 44 stops the post-processing circuit 28 and closes the 3GP file of a writing destination through the I/F 40.

Upon completion of closing the file, the CPU 44 designates a column in a vacant state on a file management table TBL shown in FIG. 7, and additionally writes a file number of the newly-created MP4 file and/or 3GP file in the designated column. Furthermore, the CPU 44 describes the value of the flag FLG_mp4 in a column of Item1 in the designated column, describes the value of the flag FLG_{—}3gp in a column of Item2 in the designated column, and describes the value of the flag FLG_Link in a column of Item3 in the designated column.

According to FIG. 7, regarding a file number “0001”, only the MP4 file is created, and regarding a file number “0002”, both the MP4 file and the 3GP file are created. Moreover, regarding a file number “0003”, only the 3GP file is created, and regarding a file number “0004”, both the MP4 file and the 3GP file are created. Furthermore, a link is formed on the MP4 file and 3GP file having the file number “0002” while the link is removed from the MP4 file and 3GP file having the file number “0004”. It is noted that the file management table TBL also is managed in the non-volatile state.

When a reproduction mode is selected by the key input device 38, the CPU 44 executes the following process under a reproduction task. Firstly, a head column of the file management table TBL is designated. If a value of the Item1 in the designated column is “1”, then the MP4 file having the file number described in the designated column is designated as a reproduction file. On the other hand, if the value of the Item1 in the designated column is “0”, then the 3GP file having the file number described in the designated column is designated as the reproduction file. Upon completion of designating the reproduction file, a reproducing process in which the designated reproduction file is noticed is executed.

When the reproduction file is the MP4 file, the I/F 40 writes the compressed image data accommodated in the reproduction file into the recording image area 24d through the memory control circuit 22. The MP4 codec 36 reads out the compressed image data accommodated in the recording image area 24d through the memory control circuit 22, decompresses the read-out compressed image data according to an MPEG4 system, and writes the decompressed image data into the YUV image area 24b through the memory control circuit 22.

When the reproduction file is the 3GP file, the I/F 40 writes the compressed image data accommodated in the reproduction file into the recording image area 24e through the memory control circuit 22. The MP4 codec 36 reads out the compressed image data accommodated in the recording image area 24e through the memory control circuit 22, decompresses the read-out compressed image data according to the MPEG4 system, and writes the decompressed image data into the YUV image area 24c through the memory control circuit 22.

The LCD driver 32 reads out the image data thus accommodated in the YUV image area 24b or 24c through the memory control circuit 22, and drives the LCD monitor 34 based on the read-out image data. As a result, a corresponding moving image is displayed on the LCD monitor 34.

When a forwarding manipulation is performed after the reproducing process, the CPU 44 determines whether the reproduction file is the MP4 file or the 3GP file, and determines whether the value of the Item2 in the designated column is either “0” or “1”.

When the reproduction file is the 3GP file, or when the reproduction file is the MP4 file and the value of the Item2 in the designated column is “0”, the CPU 44 designates a subsequent column on the file management table TBL, and returns to the process for designating the above-described reproduction file.

On the other hand, when the reproduction file is the MP4 file and the value of the Item2 in the designated column is “1”, the CPU 44 designates, as the reproduction file, the 3GP file having the file number described in the designated column, and executes the above-described reproducing process by noticing the designated 3GP file.

Therefore, based on the description of the file management table TBL shown in FIG. 7, the file reproduction is executed, in order, SNY0001.MP4, SNY0002.MP4, MOV0002.3GP, MOV0003.3GP, SNY0004.MP4, and MOV0004.3GP (see FIG. 8).

When a link-setting changing manipulation is performed, the value of the Item3 in the designated column is changed between “0” and “1” as long as both the Item1 and Item2 indicate “1”. As a result, if the value of the Item3 before a link setting manipulation is “0”, then the value of the Item3 after the link setting manipulation indicates “1”. Moreover, if the value of the Item3 before the link setting manipulation is “1”, then the value of the Item3 after the link setting manipulation indicates “0”.

Therefore, when the link-setting changing manipulation is performed in a state where the MP4 file “SANY0002.MP4” or the 3GP file “MOV0002.3GP” is designated as the reproduction file, the value of the Item 3 in a second column is changed between “0” and “1”.

When an editing manipulation or a deleting manipulation is performed, the CPU 44 performs an editing process or a deleting process on the reproduction file. When the editing process is executed, a first half or a second half of the image data accommodated in the reproduction file is deleted. When the deleting process is executed, the reproduction file is deleted.

Upon completion of the editing process or the deleting process on the reproduction file, it is determined whether or not the value of the Item3 in the designated column indicates “1”. When the value of the Item3 is “1”, an editing process or a deleting process of a link file is executed corresponding to the editing process or the deleting process of the reproduction file. Therefore, when the first half of the image data accommodated in the reproduction file is deleted, the first half of the image data accommodated in the link file is similarly deleted, and when the second half of the image data accommodated in the reproduction file is deleted, the second half of the image data accommodated in the link file is similarly deleted. Moreover, when the whole of the reproduction file is deleted, the whole of the link file is deleted.

It is noted that the link file is an image file having the same file number as the file number of the designated file. For example, if the designated file is “SANY0002.MP4”, then “MOV002.3GP” is the link file.

When the whole of the reproduction file is deleted, the CPU 44 executes a process different depending on the value of the Item3 in the designated column.

If the value of the Item3 in the designated column is “0”, then the value of the Item1 or the Item2 in the designated column is changed to “0”. That is, if the reproduction file is the MP4 file, then the value of the Item1 is changed to “0”, and if the reproduction file is the 3GP file, then the value of the Item2 is changed to “0”. Therefore, in an example of FIG. 7, if the MN file “SANY0004.MP4” is deleted, the value of the Item1 in a fourth column is changed from “1” to “0”. Upon completion of the change process, a subsequent column is designated, and thereafter, the process returns to the process for designating the reproduction file.

If the value of the Item3 in the designated column is “1”, then the description in the designated column is deleted, and the description in a column after the subsequent column is shifted upwardly by one level. Therefore, in the example of FIG. 7, if the 3GP file “MOV0002.3GP” is deleted, the description of the second column is deleted and the description in a column after the third column is shifted upwardly by one level. Upon completion of the shift process, the process returns to the above-described process for designating the reproduction file.

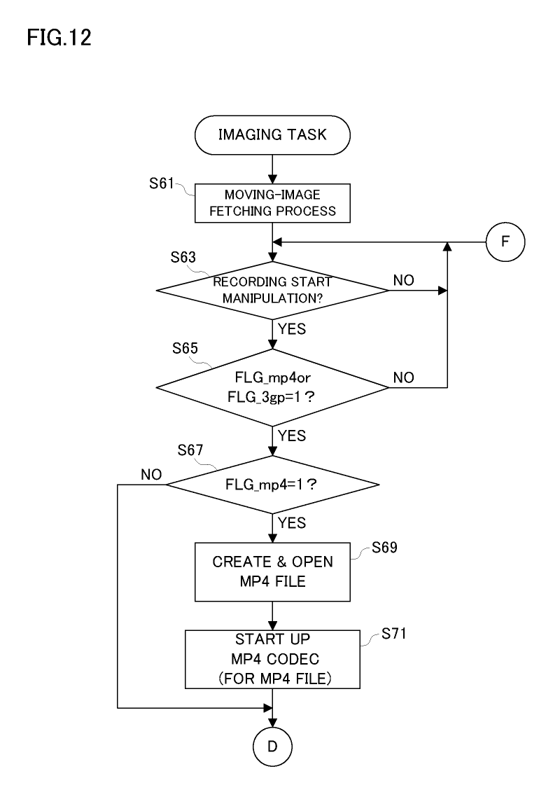

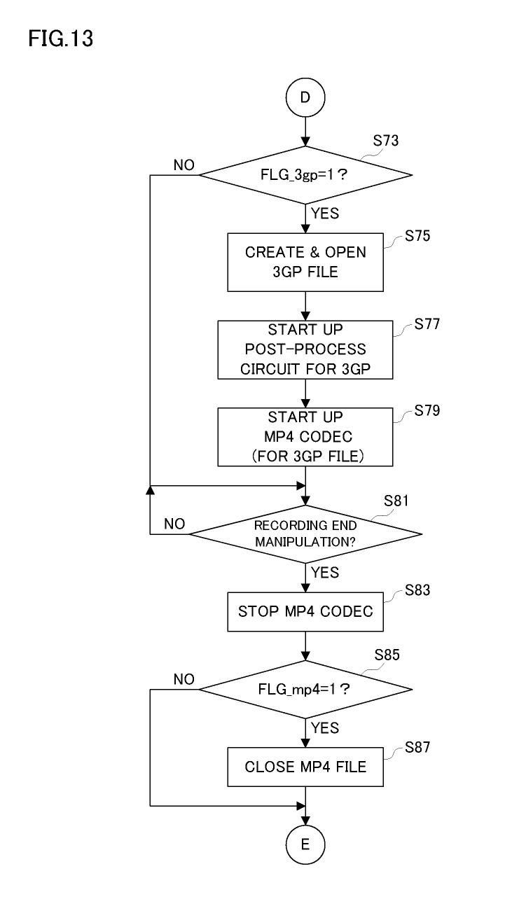

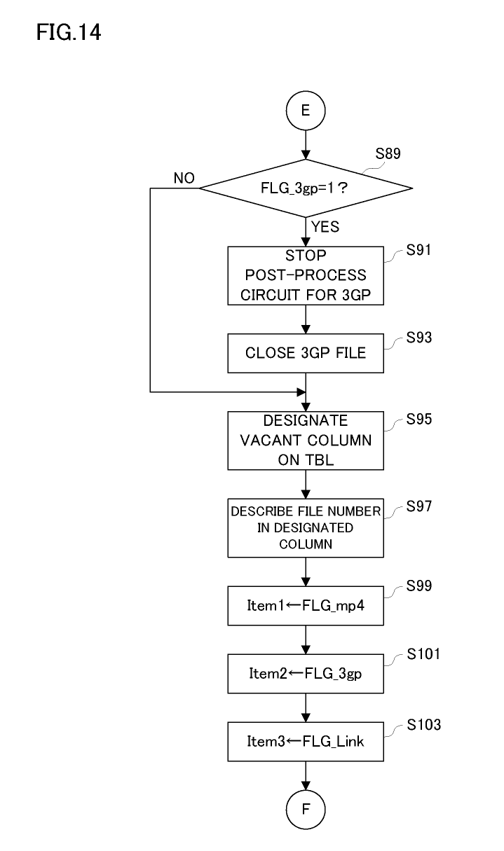

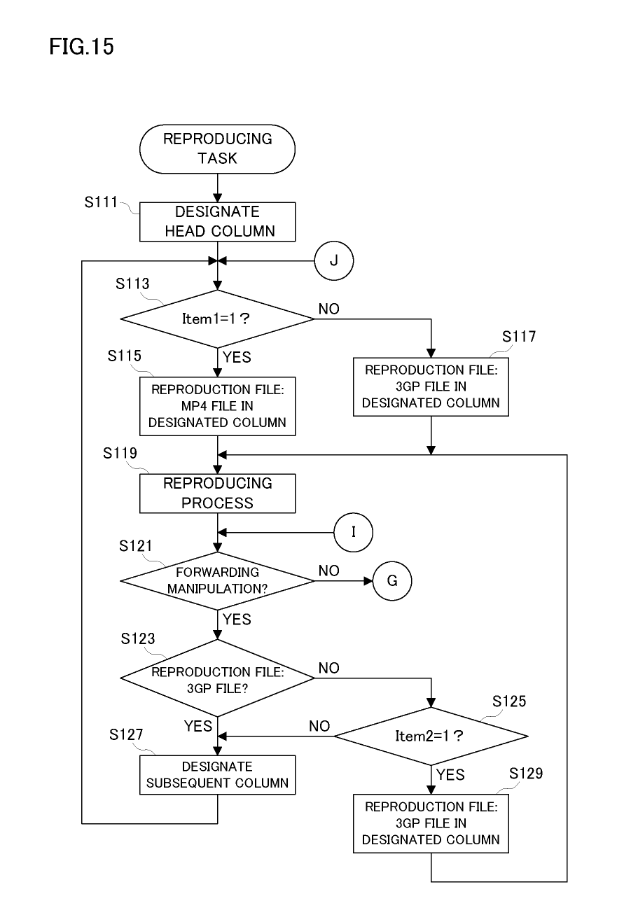

When the setting adjusting mode is selected, the CPU 44 executes a setting control task shown in FIG. 9 to FIG. 11. When the camera mode is selected, the CPU 44 executes a plurality of tasks including an imaging task shown in FIG. 12 to FIG. 14, an imaging-condition adjusting task and a recording control task not shown, in a parallel manner. When the reproduction mode is selected, the CPU 44 executes a reproduction task shown in FIG. 15 to FIG. 17. It is noted that control programs corresponding to these tasks are stored in a flash memory 48.

With reference to FIG. 9, in a step S1, the main-menu display command is issued toward the overlay graphic generator 30. As a result, the main menu shown in FIG. 5(A) is displayed on the LCD monitor 34.

In a step S3, it is determined whether or not the determination manipulation is performed, and in a step S5, it is determined whether or not the cursor movement manipulation is performed. When YES is determined in the step S5, the cursor CS1 is moved to a desired location in a step S7, and thereafter, the process returns to the step S3. When YES is determined in the step S3, the pointing destination of the cursor CS1 is determined in steps S9 and S11.

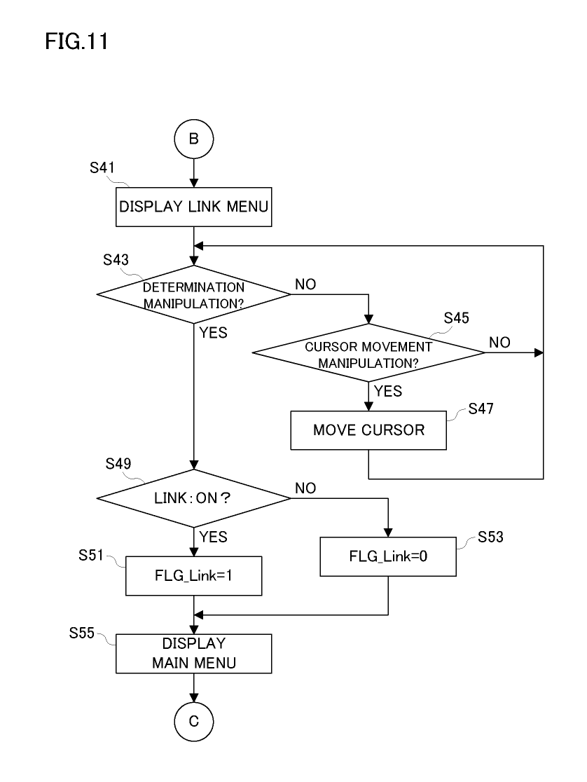

If the pointing destination of the cursor CS1 is “coding setting”, then YES is determined in the step S9, and the process advances to a step S19 shown in FIG. 10. If the pointing destination of the cursor CS1 is “link setting”, then the process advances from the step S11 to a step S17 so as to determine whether or not both the flags FLG_mp4 and FLG_{—}3gp indicate “1”. When a determined result is YES, the process advances to a step S41 shown in FIG. 11 while when the determined result is NO, the process returns to the step S3.

If the pointing destination of the cursor CS1 is an item other than “coding setting” and “link setting”, NO is determined in the both steps S9 and S11. In a step S13, another process is executed. Upon completion of the process in the step S13, in a step S15, the process executes a process similar to that in the above-described step S1, and then, the process returns to the step S3.

With reference to FIG. 10, in the step S19, the coding-menu display command is issued toward the overlay graphic generator 30. The display of the LCD monitor 34 is updated from the main menu shown in FIG. 5(A) to the coding menu shown in FIG. 5(B).

In a step S21, it is determined whether or not the determination manipulation is performed, and in a step S23, it is determined whether or not the cursor movement manipulation is performed.

When YES is determined in the step S23, the cursor CS2 and/or CS3 is moved to a desired location in a step S25, and thereafter, the process returns to the step S21. When YES is determined in the step S21, the pointing destination of the cursor CS2 is determined in a step S27, and the pointing destination of the cursor CS3 is determined in a step S33.

When the cursor CS2 points at “ON”, the process advances from the step S27 to a step S29 so as to set the flag FLG_mp4 to “1”. On the other hand, when the cursor CS2 points at “OFF”, the process advances from the step S27 to a step S31 so as to set the flag FLG_mp4 to “0”.

When the cursor CS3 points at “ON”, the process advances from the step S33 to a step S35 so as to set the flag FLG_{—}3gp to “1”. On the other hand, when the cursor CS3 points at “OFF”, the process advances from the step S33 to a step S37 so as to set the flag FLG_{—}3gp to “0”. Upon completion of setting the flags FLG_mp4 and FLG_{—}3gp, a process similar to that in the above-described step S1 is executed in a step S39, and thereafter, the process returns to the step S3.

With reference to FIG. 11, in the step S41, the link-menu display command is issued toward the overlay graphic generator 30. The display on the LCD monitor 34 is transitioned from the main menu shown in FIG. 5(A) to that shown in FIG. 5(C).

In a step S43, it is determined whether or not the determination manipulation is performed, and in a step S45, it is determined whether or not the cursor movement manipulation is performed. When YES is determined in the step S45, the cursor CS4 is moved to a desired location in a step S47, and thereafter, the process returns to the step S43. When YES is determined in the step S43, the pointing destination of the cursor CS4 is determined in a step S49.

When the cursor CS4 points at “ON”, the process advances from the step S49 to a step S51 so as to set the flag FLG_Link to “1”. On the other hand, when the cursor CS4 points at “OFF”, the process advances from the step S49 to a step S53 so as to set the flag FLG_Link to “0”. Upon completion of the process in the step S51 or S53, the process executes in a step S55 a process similar to that in the above-described step S1, and thereafter, the process returns to the step S3.

With reference to FIG. 12, in a step S61, the moving-image fetching process is executed. Thereby, the through image is displayed on the LCD monitor 34. In a step S63, it is repeatedly determined whether or not the recording start manipulation is performed. In a step S65, it is repeatedly determined whether or not at least one of the flags FLG_mp4 and FLG_{—}3gp indicates “1”.

When a determined result in at least one of the steps S63 and S65 is NO, the process returns to the step S63. When the determined results in both the steps S63 and S65 are YES, the value of the flag FLG_mp4 is determined in a step S67 and the value of the flag FLG_{—}3gp is determined in a step S73.

If the value of the flag FLG_mp4 is “1”, then processes in steps S69 to S71 are executed, and if the value of the flag FLG_mp4 is “0”, then the processes in the steps S69 to S71 are omitted. Furthermore, if the value of the flag FLG_{—}3gp is “1”, then processes in steps S75 to S79 are executed, and if the value of the flag FLG_{—}3gp is “0”, then the processes in the steps S75 to S79 are omitted.

In the step S69, the recording medium 42 is accessed through the I/F 40 to newly create the MP4 file in the opened state onto the recording medium 42. In the step S71, for the recording process into the MP4 file, the MP4 codec 36 is started up.

The MP4 codec 36 repeatedly reads out the image data in the 1080/60i system accommodated in the YUV image area 24b through the memory control circuit 22, compresses the read-out image data according to the MPEG4 system, and writes the compressed image data into the recording image area 24d through the memory control circuit 22.

In the step S75, the recording medium 42 is accessed through the I/F 40 to newly create the 3GP file in the opened state onto the recording medium 42. In the steps S77 and S79, for the recording process into the 3GP file, the post-processing circuit 28 and the MP4 codec 36 are respectively started up.

The post-processing circuit 28 reads out one portion of the raw image data belonging to the cut-out area CT2 through the memory control circuit 22 so as to create the image data in the 480/30i system based on the read-out raw image data, and writes the created image data into the YUV image area 24c through the memory control circuit 22.

The MP4 codec 36 repeatedly reads out the image data in the 480/30i system accommodated in the YUV image area 24c through the memory control circuit 22, compresses the read-out image data according to the MPEG4 system, and writes the compressed image data into the recording image area 24e through the memory control circuit 22.

In a step S81, it is determined whether or not the recording end manipulation is performed. When a determined result is updated from NO to YES, the MP4 codec 36 is stopped in a step S83. Moreover, the value of the flag FLG_mp4 is determined in a step S85, and at the same time, the value of the flag FLG_{—}3gp is determined in a step S89.

If the value of the flag FLG_mp4 is “1”, then a process in a step S87 is executed, and if the value of the flag FLG_mp4 is “0”, then the process in the step S87 is omitted. Furthermore, if the value of the flag FLG_{—}3gp is “1”, then processes in steps S91 to S93 are executed, and if the value of the flag FLG_{—}3gp is “0”, then the processes in the steps S91 to S93 are omitted.

In the step S87, the recording medium 42 is accessed through the I/F 40 so as to close the MP4 file in the opened state. In the step S91, the post-processing circuit 28 is stopped. In the step S93, the recording medium 42 is accessed through the I/F 40 so as to close the 3GP file in the opened state.

Upon completion of closing the file, the process advances to a step S95 so as to designate a column in a vacant state on the file management table TBL. In a step S97, the file number of the closed MP4 file and/or 3GP file is described in the designated column. In a step S99, the value of the flag FLG_mp4 is set to the Item1 in the designated column. In a step S101, the value of the flag FLG_{—}3gp is set to the Item2 in the designated column. In a step S103, the value of the flag FLG_Link is set to the Item3 in the designated column. Upon completion of the process in the step S103, the process returns to the step S63.

With reference to FIG. 15, in a step S111, the head column of the file management table TBL is designated, and in a step S113, it is determined whether or not the value of the Item1 in the designated column is “1”. When a determined result is YES, the process advances to a step S115 so as to designate, as the reproduction file, the MP4 file corresponding to the description in the designated column. On the other hand, when the determined result is NO, the process advances to a step S117 so as to designate, as the reproduction file, the 3GP file corresponding to the description in the designated column.

In a step S119, the reproducing process in which the reproduction file designated in the step S115 or S117 is noticed is executed. As a result, the moving image based on the image data accommodated in the reproduction file is displayed on the LCD monitor 34.

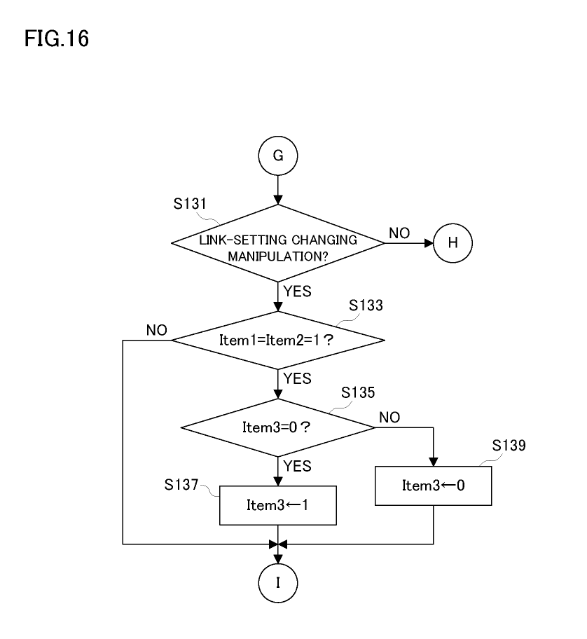

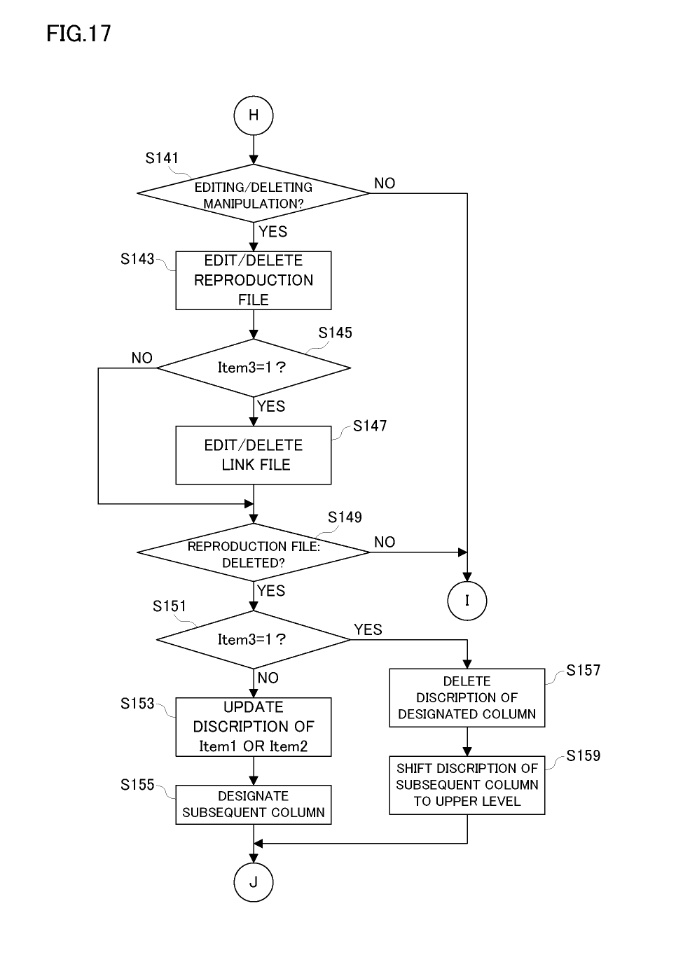

Upon completion of the reproducing process, it is determined in a step S121 whether or not the forwarding manipulation is performed, it is determined in a step S131 shown in FIG. 16 whether or not the link-setting changing manipulation is performed, and it is determined in a step S141 shown in FIG. 17 whether or not the editing/deleting manipulation is performed.

When the forwarding manipulation is performed, it is determined in a step S123 whether or not the reproduction file is the 3GP file, and it is determined in a step S125 whether or not the value of the Item2 in the designated column is “1”. If YES is determined in the step S123 or NO is determined both in the steps S123 and S125, then a subsequent column is designated in a step S127. Thereafter, the process returns to the step S113. If NO is determined in the step S123 and YES is determined in the step S125, then the process advances to a step S129 so as to designate, as the reproduction file, the 3GP file corresponding to the description in the designated column. Upon completion of the process in the step S129, the process returns to the step S119.

When the link-setting changing manipulation is performed, the process advances from the step S131 shown in FIG. 15 to a step S133 so as to determine whether or not both the Item1 and Item2 in the designated column indicate “1”. When a determined result is NO, the process returns to the step S121, and when the determined result is YES, the process advances to a step S135.

In the step S135, it is determined whether or not the value of the Item3 in the designated column is “0”. When a determined result is YES, the value of the Item3 is changed to “1” in a step S137 while when the determined result is NO, the value of the Item3 is changed to “0” in a step S139. Upon completion of the process in the step S137 or 5139, the process returns to the step S121.

When the editing manipulation or the deleting manipulation is performed, the process advances from the step S141 shown in FIG. 17 to a step S143 so as to perform the editing process or the deleting process on the reproduction file. In a step S145, it is determined whether or not the value of Item3 in the designated column indicates “1”. When a determined result is NO, the process directly advances to a step S149, and on the other hand, when the determined result is YES, the process advances to the step S149 via a step S147. In the step S147, corresponding to the editing process or the deleting process in the step S143, the editing process or the deleting process is performed on the link file.

In the step S149, it is determined whether or not the reproduction file is deleted, and when a determined result is NO, the process returns to the step S121 while when the determined result is YES, the process advances to a step S151. In the step S151, it is determined whether or not the value of the Item3 in the designated column indicates “1”, and when NO is determined, the process advances to a step S153 while when YES is determined, the process advances to a step S157.

In the step S153, the value of the Item1 or Item2 in the designated column is changed to “0”. That is, if the reproduction file is the MP4 file, then the value of the Item1 is changed to “0”, and if the reproduction file is the 3GP file, then the value of the Item2 is changed to “0”. Upon completion of the change process, a subsequent column is designated in a step S155, and thereafter, the process returns to the step S113. In the step S157, the description in the designated column is deleted, and in a step S159, the description of a column after the subsequent column is shifted upwardly by one level. Upon completion of the process in the step S159, the process returns to the step S113.

As can be seen from the above-described explanation, the image data representing the motion of the scene is fetched to the SDRAM 24 by the moving-image fetching process. Along with converting the fetched image data into the compressed image data for the MP4 file, and at the same time, the MP4 codec 36 converts the same into the compressed image data for the 3GP file. The compressed image data, which is the former, is accommodated into the MP4 file, and the compressed image data, which is the latter, is accommodated into the 3GP file.

The CPU 44 edits one of the MP4 file and the 3GP file associated to each other, in response to the editing manipulation (S133), and edits the other of the MP4 file and the 3GP file associated to each other, corresponding to the editing process (S137).

Because of the MP4 codec 36 performing two types of converting processes on the common image data, the image representing the common scene is contained in the MP4 file and the 3GP file. When one of such MP4 file and 3GP file is edited, the other of the MP4 file and the 3GP file is edited in a corresponding manner. Thereby, it becomes possible to reduce complications caused at the time of managing or editing a plurality of recording images representing the common scene.

Furthermore, the CPU 44 sets the value of the Item3 to be written from now onto the file management table TBL uniformly to a value that complies with the menu manipulation prior to the recording start manipulation (S99), and sets the value of the Item3 corresponding to the reproduced MP4 file or 3GP file individually to a value that complies with the link-setting changing manipulation (S127 to S129). With reference to the thus-set value of the Item3, the CPU 44 permits/restricts the editing process on the 3GP data (S135). Thereby, it becomes possible to reflect a user's intension on the editing process.

It is noted that in this embodiment, a digital video camera is assumed; however, the present invention may also be applied to a stationary video recorder.

Moreover, in this embodiment, the editing process and the deleting process are distinguished; however, if a broader interpretation is applied, the deleting process may be understood as one portion of the editing process. Similarly, the deleting manipulation may be understood as one portion of the editing manipulation.

Furthermore, in this embodiment, the cut-out area CT1 has a resolution equivalent to horizontal 1920 pixels×vertical 1080 pixels (its aspect ratio is 16:9), and the cut-out area CT2 has a resolution equivalent to horizontal 640 pixels×vertical 480 pixels (its aspect ratio is 4:3). However, the following may be possible: an area having a resolution different from the horizontal 1920 pixels×vertical 1080 pixels is prepared as the cut-out area CT1 while maintaining the aspect ratio of 16:9, and an area having a resolution different from the horizontal 640 pixels×vertical 480 pixels is prepared as the cut-out area CT2 while maintaining the aspect ratio of 4:3.

Moreover, the aspect ratio and/or resolution may be coincident between the cut-out areas CT1 and CT2. Furthermore, the aspect ratio is not restricted to 16:9 or 4:3, and the resolutions of the cut-out areas CT1 and CT2 are not restricted to the above-described resolutions.

Moreover, in this embodiment, when the editing process is executed, the first half or the second half of the image data accommodated in the reproduction file is deleted. However, in the editing process, a middle portion of the image data may be deleted, and both the first half and the second half of the image data may be deleted.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a fetcher which fetches an original image;
a first converter which converts the original image fetched by said fetcher into a first recording image;
a second converter which converts the original image fetched by said fetcher into a second recording image, in association with the converting process of said first converter;
a first editor which edits one of the first recording image converted by said first converter and the second recording image converted by said second converter, in response to an editing instruction; and
a second editor which edits the other of the first recording image converted by said first converter and the second recording image converted by said second converter, corresponding to an editing process of said first editor.

2. An image processing apparatus according to claim 1, further comprising:
a creator which creates link information indicating presence or absence of a link between the first recording image and the second recording image that are based on a common original image; and
a first controller which permits/restricts an editing process of said second editor, with reference to the link information created by said creator.

3. An image processing apparatus according to claim 2, further comprising a first acceptor which accepts a first link-control manipulation prior to the fetching process of said fetcher, wherein said creator includes a link information creator which creates the link information in a manner to be adapted to the first link-control manipulation in association with the converting process of said first converter and/or said second converter.

4. An image processing apparatus according to claim 3, further comprising:
a reproducer which reproduces the first recording image converted by said first converter and/or the second recording image converted by said second converter; and
a second acceptor which accepts a second link-control manipulation in association with the reproducing process of said reproducer, wherein said creator further includes a link information modifier which modifies the link information corresponding to the recording image reproduced by said reproducer in a manner to be adapted to the second link-control manipulation.

5. An image-process program product executed by a processor of an image processing apparatus, comprising:
a fetching step of fetching an original image;
a first converting step of converting the original image fetched by said fetching step into a first recording image;
a second converting step of converting the original image fetched by said fetching step into a second recording image, in association with the converting process of said first converting step;
a first editing step of editing one of the first recording image converted by said first converting step and the second recording image converted by said second converting step, in response to an editing instruction; and
a second editing step of editing the other of the first recording image converted by said first converting step and the second recording image converted by said second converting step, corresponding to an editing process of said first editing step.

6. An image processing method executed by an image processing apparatus, comprising:
a fetching step of fetching an original image;
a first converting step of converting the original image fetched by said fetching step into a first recording image;
a second converting step of converting the original image fetched by said fetching step into a second recording image, in association with the converting process of said first converting step;
a first editing step of editing one of the first recording image converted by said first converting step and the second recording image converted by said second converting step, in response to an editing instruction; and
a second editing step of editing the other of the first recording image converted by said first converting step and the second recording image converted by said second converting step, corresponding to an editing process of said first editing step.
